(19) United States
(12) Patent Application Publication
(10) Pub. No.: US 2019/0128464 A1
(43) Pub. Date: May 2, 2019

(54) Assembly and Method for Plugging and Unplugging a Port

(71) Applicant: Yeow Ng, Andover, KS (US)

(72) Inventor: Yeow Ng, Andover, KS (US)

(21) Appl. No.: 16/232,695

(22) Filed: Dec. 26, 2018

(51) Int. Cl. F16L 55/11

(52) U.S. Cl. CPC F16L 55/1141

(57) ABSTRACT

A stopper assembly incorporating an elastic conical body having a forward end and a rearward end; a base attached to the conical body's rearward end; and a pair of sockets opening at the base; and a method for using the stopper assembly including steps of providing the stopper assembly and needle nose pliers; grasping the pliers' handles and splaying pliers' jaws; inserting the nose of each such jaw into one of the sockets; squeezing the pliers' handles for clamping the pair of sockets between the pliers' jaws; moving the pliers, the base, and the elastic conical body toward and into the port; and simultaneously driving and twisting the pliers and the stopper assembly.

### FIELD OF THE INVENTION

This invention relates to stoppers and plugs for closing ports and openings. More particularly, this invention relates to stoppers having specialized adaptations for assisting in stopper insertions and stopper extractions.

### BACKGROUND OF THE INVENTION

Rubber opening or port closing stoppers are commonly inserted into and extracted from ports which are relatively inaccessible or which include peripheral or surrounding obstructions. During insertion of a rubber stopper into such a port, it is commonly desirable to simultaneously forwardly drive the stopper and to simultaneously circumferentially twist or turn the stopper about its longitudinal axis. Such simultaneous driving and turning action applied to a stopper during insertion assists in maintaining or prolonging relatively low sliding friction at the annular interface between the stopper's conical wall and the port's wall, such increase in the duration of sliding friction advantageously allowing the stopper to be more securely inserted. However, the structures and protrusions adjacent the port may undesirably mechanically interfere with and prevent an operator's utilization of a hand or a wrench to apply the needed turning force to the stopper during insertion.

During stopper extraction procedures, a similar turning twisting force is similarly desirably applied to the protruding rearward or base end of a stopper, the application of a simultaneous turning force assisting in breaking the static friction which exists between the inserted stopper and the wall of the port. Peripheral protrusions and obstructions at and around a stoppered port may similarly interfere with application of a turning force for assistance in the extraction of the stopper.

The instant inventive stopper assembly and method for plugging and unplugging a port solves or ameliorates the problems and challenges discussed above by providing a specialized stopper and stopper usage steps which allow common needle nose pliers to be utilized to assist in stopper insertions and extractions at tightly spaced locations.

### BRIEF SUMMARY OF THE INVENTION

A first structural component of the instant inventive stopper assembly comprises an elastic conical body having a forward insertion end and having a rearward end. In a preferred embodiment, the elastic conical body is composed of nitrile butadiene rubber (NBR) or is composed of silicone rubber. Also in the preferred embodiment, the elastic conical body presents a progressive range of differently sized circular cross-sections in order to match and fit the plug for use upon a range of sizes of port openings.

A further structural component of the instant inventive stopper assembly comprises a base which is fixedly attached to, formed wholly, or is integrally molded with the elastic conical body's rearward end.

A further structural component of the instant inventive stopper assembly comprises a pair of sockets, each socket among the pair of sockets extending forwardly into the base, and opening rearwardly.

In use of the instant inventive stopper assembly, an operator may additionally provide needle nose pliers whose handles and jaws may be initially splayed until the noses or forward ends of the jaws displace a distance from each other matching the separation distance of the stopper's pair of sockets.

Thereafter, the noses of the pliers' jaws may be forwardly inserted into the rearwardly opening sockets, and the pliers' handles may be squeezed toward each other in order to cause the jaws to clamp and hold the stopper at its sockets.

With the inventive stopper held by such pliers, the operator may forwardly extend both the pliers and the stopper toward a port to be plugged. During such forward extension, the stopper and plier jaws conveniently pass the port's periphery situated obstructions without interference. Thereafter, the operator may further forwardly drive the stopper into the port and may simultaneously axially turn or twist the stopper via manually applied torque to the pliers.

The above described pliers actuated stopper insertion steps may be most advantageously performed in circumstances where structures and protrusions at and about the port prevent utilization of other tools such as wrenches, or prevent the operator's direct use of his or her hand and fingers for application of the needed turning force to the stopper.

A reversal of steps described above effectively allows the provided pliers to lend assistance in the stopper's extraction.

In a preferred embodiment, the inventive stopper incorporates a plurality of torsion lands which are formed or molded at the periphery of the stopper's base. Also, in the preferred embodiment, the torsion lands configure the base as a square having four orthogonal faces. In situations where the stopper is to be utilized for plugging and unplugging a port which is removed from any adjacent obstructions or protuberances, the jaws of a wrench engaged with opposing lands of such orthogonal base, and the wrench may be utilized as an alternative means for application of the needed turning force. Such square configuration of the base also provides convenient finger grip surfaces which allow direct hand actuated turning of the stopper.

Accordingly, objects of the instant invention include the provision of a stopper assembly and method steps for plugging and unplugging a port which incorporate structures and prescribe the performance of method steps as described above, and which arrange and perform those structures and steps in relation to each other in manners described above for the achievement of beneficial functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of a preferred embodiment of the instant inventive stopper assembly.

FIG. 2 is a sectional view as indicated in FIG. 1.

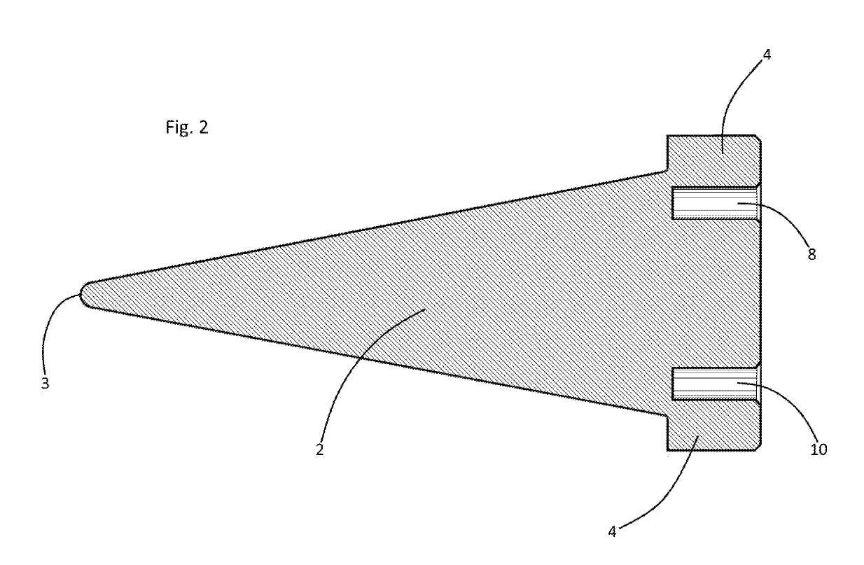

FIG. 3 presents an exemplary hydraulic fluid manifold including a port which may be plugged and unplugged through the use of the instant invention;

FIG. 4 redepicts the stopper of FIG. 1, the view of FIG. 4 additionally showing such stopper in a process of pliers assisted insertion into the exemplary port of FIG. 3.

FIG. 5 alternatively shows the inventive stopper utilized for plugging a hydraulic line.

### DETAILED DESCRIPTION OF A PREFERRED EMBODIMENT

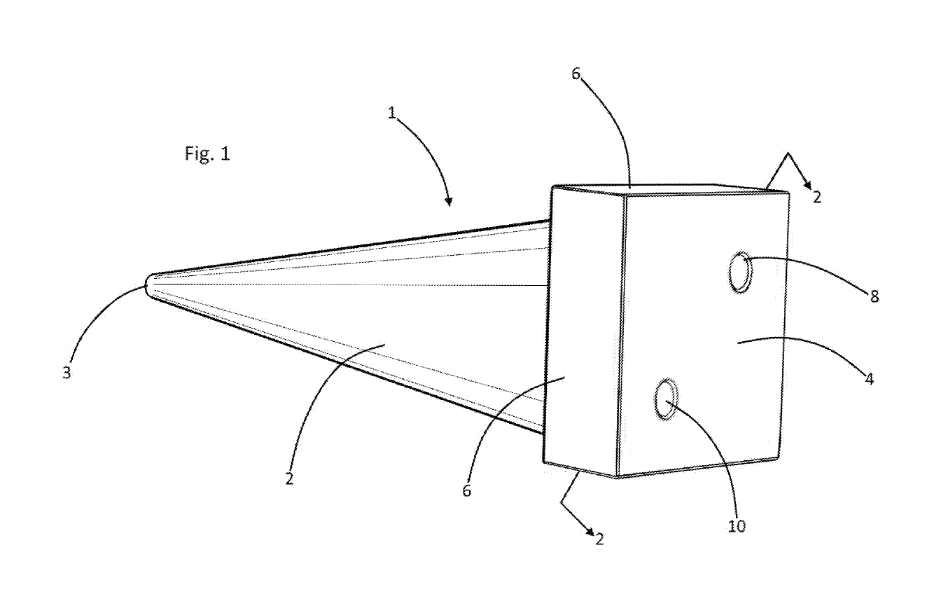

Referring now to the drawings, and in particular to Drawing FIG. 1, a preferred embodiment of the instant inventive stopper assembly is referred to generally by Reference Arrow 1. The stopper assembly 1 includes a conical body 2 having a forward insertion end 3. A base 4 is fixedly attached to or formed wholly with the rearward end of the conical body 2, the base 4 having at least a pair of forwardly extending and rearwardly opening sockets 8 and 10. In a preferred embodiment, the base 4 incorporates a plurality of torsion lands 6 about its periphery, such lands 6 suitably being orthogonally arranged with respect to each other to form a substantially square base or stopper head. In the preferred embodiment, the base 4 and the conical body 2 are integrally formed of an elastomer such as molded nitrile butadiene rubber (NBR) or silicone rubber.

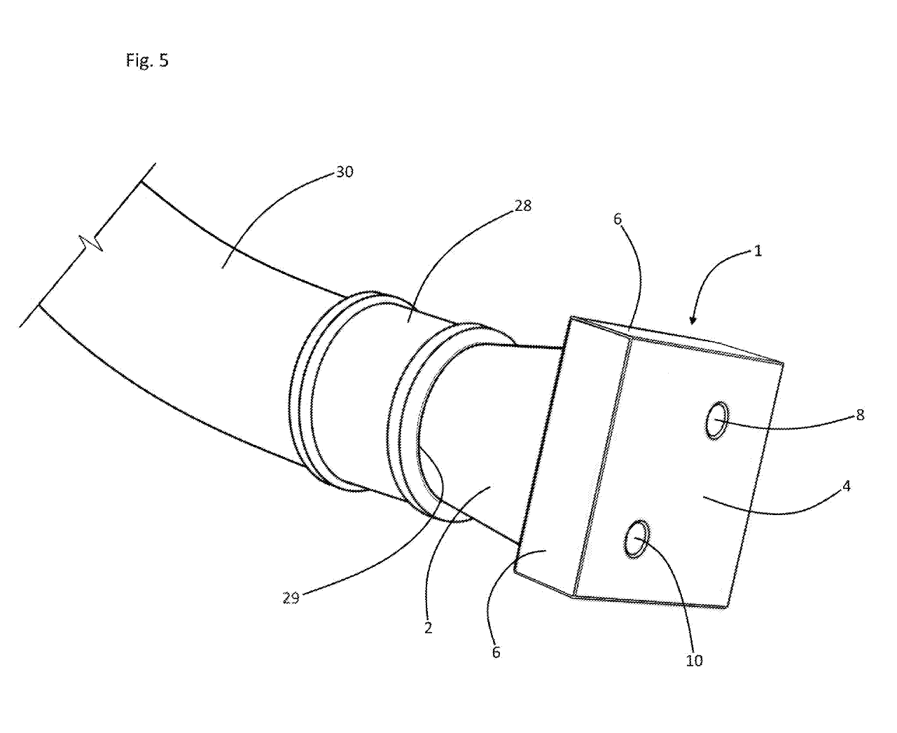

Referring to FIG. 5, a simple and unobstructed use environment for the inventive stopper 1 may comprise a terminal end 28 of a hydraulic hose 30, such end having a port or opening 29. To effect the insertion of the stopper 1 into port 29, an operator may grasp in her or his left hand the terminal end 28 of the hose 30, and may grasp the square base 4 of stopper 1. Referring further simultaneously to FIG. 1, the operator may then simultaneously extend the forward end 3 of the conical body 2 into port 29, and may continue such motion until the wall of such body meets the inner periphery of port 29. Thereafter, the operator may continue to forwardly drive the stopper 1 while applying a hand and fingers actuated circumferential turning force to the base 4. During the application of such turning force, torsion lands 6 assist in maintaining the operator's grip, enhancing the plugging seal affected by the conical body 2. A reversal of steps described above effectively removes the stopper 1 from port 29.

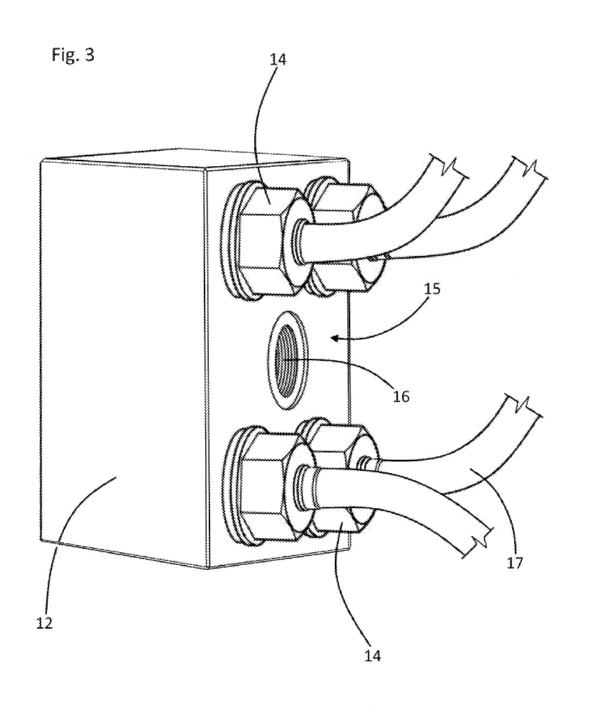

Referring simultaneously to FIGS. 3 and 5, it may be seen that an open port 16 of an exemplary hydraulic line manifold 12 differs from port 29 of hydraulic line 30 in that port 29 has no immediately surrounding obstructions or protuberances, while hose connectors 14 and hydraulic lines 17 immediately surrounding port 16 effectively create and define a restricted space 15 about and surrounding port 16. An operator seeking to alternatively insert the stopper 1 into port 16 may have difficulty utilizing his or her hand or a wrench within space 15 in order to impose the needed turning force to the stopper 1 during its insertion.

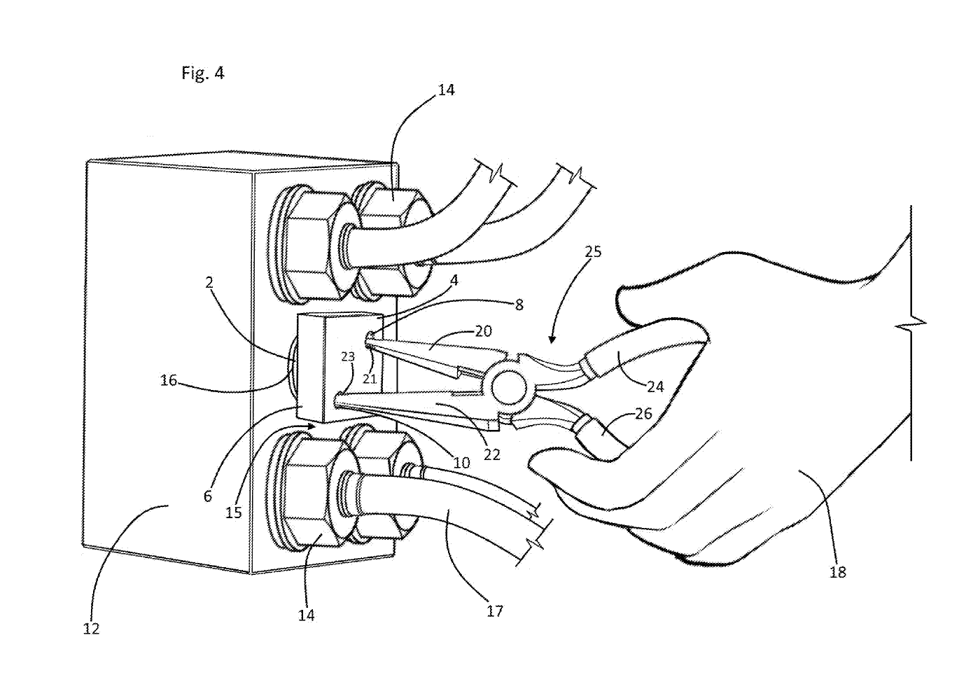

Referring simultaneously to FIGS. 3 and 4, in order to accommodate for and overcome the stopper insertion and extraction challenges presented by spaces such as restricted space 15, the operator may alternatively utilize his or her hand 18 to grasp needle nose pliers which are referred to generally by Reference Arrow 25. The operator may initially manually splay handles 24 and 26, causing needle nose plier jaws 20 and 22 to correspondingly splay. Such pliers splaying action preferably continues until the noses 21 and 23 at the forward ends of jaws 20 and 22 displace away from each other a distance substantially equal to the displacement of sockets 8 and 10 away from each other.

Thereafter, the operator may forwardly insert jaw noses 21 and 23 into sockets 8 and 10, and the handles 24 and 26 may then be squeezed toward each other. Squeezing the pliers handles 24,26 causes its jaws 20 and 22 to clamp against the base 4 utilizing sockets 8 and 10 as opposing jaw clamping lands.

With the stopper 1 clamped and held as described above, the operator may forwardly insert the forward end 3 of the conical body 2 into the port 16, and may simultaneously circumferentially turn the pliers 25. Such turning advantageously applies a twisting action to the stopper 1 during the insertion. The narrow profile of the jaws 20 and 22 of the pliers 25 advantageously allows the application of the turning force without interference with protrusions 14.

A reversal of steps described above effectively utilizes the pliers 25 for applying a twisting force to the stopper in assistance of a stopper extraction.

While the principles of the invention have been made clear in the above illustrative embodiment, those skilled in the art may make modifications to the structure, arrangement, portions, components, and method steps of the invention without departing from those principles. Accordingly, it is intended that the description and drawings be interpreted as illustrative and not in the limiting sense, and that the invention be given a scope commensurate with the appended claims.

The invention hereby claimed is:

1. A stopper assembly comprising:
(a) an elastic conical body having a forward insertion end, and having a rearward end;
(b) a base fixedly attached to or formed wholly with the elastic conical body's rearward end; and
(c) at least a pair of sockets, each socket among the pair of sockets extending forwardly into the base and opening rearwardly.

2. The stopper assembly of claim 1 wherein the base has a periphery, and further comprising a plurality of torsion lands, each torsion land being positioned at the base's periphery.

3. The stopper assembly of claim 2 wherein the torsion lands are arranged substantially orthogonally.

4. The stopper assembly of claim 3 wherein the substantially orthogonal arrangement of torsion lands forms a square.

5. The stopper assembly of claim 4 further comprising pliers having a pair of handles and having a pair of jaws, wherein each jaw has a nose, and wherein said each jaw's nose is forwardly received within one of the sockets.

6. A method for plugging and unplugging a port, the port being adjacent a plurality of obstructions, the method incorporating steps of:
(a) providing an elastic conical body having a forward end and having a rearward end, the elastic conical body's forward end being fitted for insertion into the port;
(b) providing a base fixedly attached to or formed wholly with the elastic conical body's rearward end;
(c) providing a pair of sockets, each socket among the pair of sockets extending forwardly into the base and opening rearwardly;
(d) providing pliers having a pair of handles and a pair of jaws, each jaw having a nose;
(e) splaying the pliers' handles and jaws;
(f) forwardly inserting the nose of each jaw into one of the sockets;
(g) squeezing the pliers' handles and clamping the pair of sockets between the pliers' jaws;
(h) forwardly moving the pliers, the base, and the elastic conical body toward the port, and forwardly extending said body's forward end into the port; and
(i) simultaneously forwardly driving and circumferentially turning the pliers against the base.

7. The method for plugging and unplugging the port of claim 6 further comprising steps of counter-turning and rearwardly pulling the pliers during the clamping engagement of the pliers' jaws with the sockets.
